(19) United States
(12) Patent Application Publication
(10) Pub. No.: US 2012/0253841 A1
(43) Pub. Date: Oct. 4, 2012

(54) METHOD, APPARATUS AND COMPUTER PROGRAM PRODUCT FOR PROVIDING DOCUMENTATION OF A CLINICAL ENCOUNTER HISTORY

(75) Inventors: Kara Erlandsen, Marietta, GA (US); Helmut Domagalski, (US)

(73) Assignee: McKesson Financial Holdings

(21) Appl. No.: 13/073,304

(22) Filed: Mar. 28, 2011

(51) Int. Cl. G06Q 50/00

(52) U.S. Cl. 705/3

(57) ABSTRACT

A method for providing documentation of clinical encounter history may include providing for display of an electronic medical chart having a plurality of chart sections associated with respective different healthcare related topics associated with a patient, providing for display of an encounter history defining a set of activities performed in connection with a selected encounter where each activity of the set of activities is represented by a respective activity indicator and where the encounter history is dynamically updated to include an additional activity indicator for each respective activity that is undertaken in relation to a corresponding different chart section of a current patient visit, and enabling user selection of an activity indicator to link the user to a corresponding chart section related to the corresponding activity indicated by the activity indicator. A corresponding computer program product and apparatus are also provided.

### TECHNOLOGICAL FIELD

Embodiments of the present invention relate generally to solutions for providing clinical documentation regarding patient treatment and, more particularly, to a mechanism for providing documentation of a clinical encounter history.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized provider order entry (CPOE) is another example of a development that may improve the ability to electronically access information related to a physician's orders. Many other applications are also being developed to utilize electronic information on people and processes to manage the provision of various aspects of patient care including the provision of predictive care.

As is to be expected, the demand for applications that can be used for streamlining the provision of health care services and the management of health care-related information has led to the development of many new applications by many different providers. However, these applications are often very specific to certain organizations and to certain tasks. As such, certain functionalities or solutions may be tied to specific work environments.

One of the goals of instituting the EMR has been to allow accurate patient health records to be maintained in a manner that can be shared among the potentially many different healthcare providers that a patient may see over time. Thus, the goal of having a single health record that can be manipulated and shared wherever the patient chooses to go for treatment remains. However, despite having this goal in mind, software developers have taken different approaches to making entry of data into an EMR more automated. Thus, it may be unwieldy or difficult to navigate and interpret electronic chart records in some cases. The difficulty may be particularly noticeable in relation to tracking data that corresponds to certain specific visits or encounters.

### BRIEF SUMMARY

A method, apparatus and computer program product are therefore provided to enable the provision of documentation of clinical encounter history. For example, some embodiments may provide a mechanism by which details of a particular encounter may be recorded as a series of events associated with the particular encounter. The history of each encounter may then be viewed, and the data associated therewith may be accessed from an intuitive and flexible access mechanism. Accordingly, efficient navigation and effective interpretation of electronic medical charts may be supported. Furthermore, healthcare personnel can see and appreciate, at a glance, the activities that have been conducted in connection with each encounter.

In one example embodiment, a method for providing documentation of clinical encounter history is provided. The method may include providing for display of an electronic medical chart having a plurality of chart sections associated with respective different healthcare related topics associated with a patient, providing for display of an encounter history defining a set of activities performed in connection with a selected encounter where each activity of the set of activities is represented by a respective activity indicator, and enabling user selection of an activity indicator to link the user to a corresponding chart section related to the corresponding activity indicated by the activity indicator. Providing for display of the encounter history may include dynamically updating the encounter history to include an additional activity indicator for each respective activity that is undertaken in relation to a corresponding different chart section of a current patient visit.

In another example embodiment, a computer program product for providing documentation of clinical encounter history is provided. The computer program product may include at least one computer-readable storage medium having computer-executable program code instructions stored therein. The computer-executable program code instructions may include program code instructions for providing for display of an electronic medical chart having a plurality of chart sections associated with respective different healthcare related topics associated with a patient, providing for display of an encounter history defining a set of activities performed in connection with a selected encounter where each activity of the set of activities is represented by a respective activity indicator, and enabling user selection of an activity indicator to link the user to a corresponding chart section related to the corresponding activity indicated by the activity indicator. Providing for display of the encounter history may include dynamically updating the encounter history to include an additional activity indicator for each respective activity that is undertaken in relation to a corresponding different chart section of a current patient visit.

In another example embodiment, an apparatus for providing documentation of clinical encounter history is provided. The apparatus may include processing circuitry. The processing circuitry may be configured for providing for display of an electronic medical chart having a plurality of chart sections associated with respective different healthcare related topics associated with a patient, providing for display of an encounter history defining a set of activities performed in connection with a selected encounter where each activity of the set of activities is represented by a respective activity indicator, and enabling user selection of an activity indicator to link the user to a corresponding chart section related to the corresponding activity indicated by the activity indicator. Providing for display of the encounter history may include dynamically updating the encounter history to include an additional activity indicator for each respective activity that is undertaken in relation to a corresponding different chart section of a current patient visit.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for use in connection with providing documentation of clinical encounter history according to an example embodiment of the present invention;

FIG. 2 is a block diagram showing various components that may be included in an apparatus for providing documentation of clinical encounter history according to an example embodiment of the present invention;

FIG. 3 illustrates an example of a chart for a sample patient to support a description of one example embodiment;

FIG. 4 illustrates an example in which selection of an activity indicator links to a corresponding chart section according to an example embodiment of the present invention; and

FIG. 5 is a block diagram according to an example method for providing documentation of clinical encounter history according to an example embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, many different approaches are being taken to improving EMR data entry. Generally speaking, example embodiments of the present invention may facilitate review of the activities conducted in association with a particular patient visit or encounter. This functionality may be useful for a number of reasons. For example, a healthcare worker may quickly see the activities that have already been performed in association with a current or past encounter. Knowing what has already been done for a current encounter may assist in determining what activities remain to be performed in connection with the current encounter. Having a record of the activities associated with each encounter may also provide a relatively intuitive manner by which to access past records and review patient history. Additionally, recording the activities associated with each encounter can also enable determinations to quickly be made as to whether a particular encounter satisfies requirements for being awarded monies, for example, in connection with meeting Meaningful Use standards. Meaningful Use standards identify federal regulations governing dispersal of stimulus refunds and credits to providers who achieve certain goals with respect to implementation of electronic record systems.

Some example embodiments may provide an encounter documentation function that provides a historical record of activity indicators identifying each chart section for which activity has occurred in connection with a particular encounter (or healthcare related visit) associated with a patient. The activity indicators may be selectable to provide access to the corresponding chart section to review data corresponding to the particular encounter. Encounters, and the corresponding historical record associated with each encounter, may be selected by date or from a sequential listing of encounters. Accordingly, each activity indicator associated with each encounter in a patient's record may be selectable to provide one mechanism by which navigation through a patient's record may be accomplished. The activities performed in connection with each encounter can therefore easily be appreciated, and details regarding those activities can also be easily accessed.

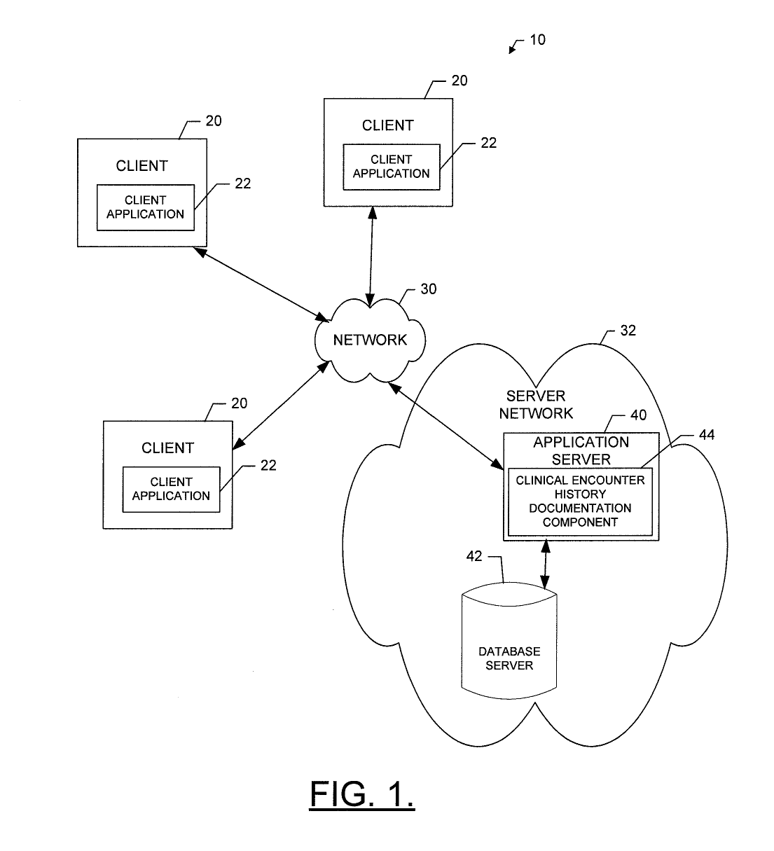

An example embodiment of the invention will now be described in reference to FIG. 1, which illustrates an example system in which an embodiment of the present invention may be employed. As shown in FIG. 1, a system 10 according to an example embodiment may include one or more clients 20 that may, in some cases, be associated with different corresponding healthcare related entities associated with one or more healthcare organizations or systems. For example, among the clients 20, one client may be associated with a first facility and a second client may be associated with a second facility. The facilities (and the corresponding clients) may be within the same healthcare organization or system or the facilities could be associated with different healthcare organizations or systems. As such, in some cases, multiple clients may be associated with the same organization.

Each one of the clients 20 may be, for example, a computer (e.g., a personal computer, laptop computer, network access terminal, or the like) or may be another form of computing device (e.g., a personal digital assistant (PDA), cellular phone, smart phone, or the like) capable of communication with a network 30. As such, for example, each one of the clients 20 may include (or otherwise have access to) memory for storing instructions or applications for the performance of various functions and a corresponding processor for executing stored instructions or applications. Each one of the clients 20 may also include software and/or corresponding hardware for enabling the performance of the respective functions of the clients as described below. In an example embodiment, one or more of the clients 20 may include a client application 22 configured to operate in accordance with an example embodiment of the present invention. In this regard, for example, the client application 22 may include software for enabling a respective one of the clients 20 to communicate with the network 30 for requesting and/or receiving a clinical encounter history documentation component in the form of a deliverable component (e.g., as downloadable software to configure the client, or as a transferable memory device including instructions to configure the client). As such, for example, the client application 22 may include corresponding executable instructions for configuring the client 20 to provide corresponding functionalities as described in greater detail below.

The network 30 may be a data network, such as a local area network (LAN), a metropolitan area network (MAN), a wide area network (WAN) (e.g., the Internet), and/or the like, which may couple the clients 20 to devices such as processing elements (e.g., personal computers, server computers or the like) or databases. Communication between the network 30, the clients 20 and the devices or databases (e.g., servers) to which the clients 20 are coupled may be accomplished by either wireline or wireless communication mechanisms and corresponding protocols.

In an example embodiment, one of the devices to which the clients 20 may be coupled via the network 30 may include one or more application servers (e.g., application server 40), and/or a database server 42, which together may form respective elements of a server network 32. Although the application server 40 and the database server 42 are each referred to as “servers,” this does not necessarily imply that they are embodied on separate servers or devices. As such, for example, a single server or device may include both entities and the database server 42 could merely be represented by a database or group of databases physically located on the same server or device as the application server 40. The application server 40 and the database server 42 may each include hardware and/or software for configuring the application server 40 and the database server 42, respectively, to perform various functions. As such, for example, the application server 40 may include processing logic and memory enabling the application server 40 to access and/or execute stored computer readable instructions for performing various functions. In an example embodiment, one function that may be provided by the application server 40 may be the provision of a clinical encounter history documentation component or the provision of services provided by a clinical encounter history documentation component of an example embodiment.

In some embodiments, for example, the application server 40 may therefore include an instance of a clinical encounter history documentation component 44 comprising stored instructions for handling activities associated with practicing example embodiments as described herein. As such, in some embodiments, the clients 20 may access the clinical encounter history documentation component 44 online and utilize the services provided thereby. However, it should be appreciated that in other embodiments, the clinical encounter history documentation component 44 may be provided from the application server 40 (e.g., via download over the network 30) to one or more of the clients 20 to enable recipient clients to instantiate an instance of the clinical encounter history documentation component 44 for local operation. As yet another example, the clinical encounter history documentation component 44 may be instantiated at one or more of the clients 20 responsive to downloading instructions from a removable or transferable memory device carrying instructions for instantiating the clinical encounter history documentation component 44 at the corresponding one or more of the clients 20. In such an example, the network 30 may not be needed or utilized at all.

In an example embodiment, the application server 40 may include or have access to memory (e.g., internal memory or the database server 42) for storing instructions or applications for the performance of various functions and a corresponding processor for executing stored instructions or applications. For example, the memory may store an instance of the clinical encounter history documentation component 44 configured to operate in accordance with an example embodiment of the present invention. In this regard, for example, the clinical encounter history documentation component 44 may include software for enabling the application server 40 to communicate with the network 30 and/or the clients 20 for the provision and/or receipt of information associated with performing clinical documentation as described herein.

As such, the environment of FIG. 1 illustrates an example in which provision of clinical encounter history documentation (e.g., in a healthcare record or EMR) may be accomplished by a particular entity (namely the clinical encounter history documentation component 44 residing at the application server 40). However, it should be noted again that the clinical encounter history documentation component 44 could alternatively handle provision of clinical documentation support within a single facility. Thus, in some embodiments, the clinical encounter history documentation component 44 may be embodied at one or more of the clients 20 and, in such an example, the clinical encounter history documentation component 44 may be configured to handle provision of clinical encounter history documentation support only for the corresponding facility.

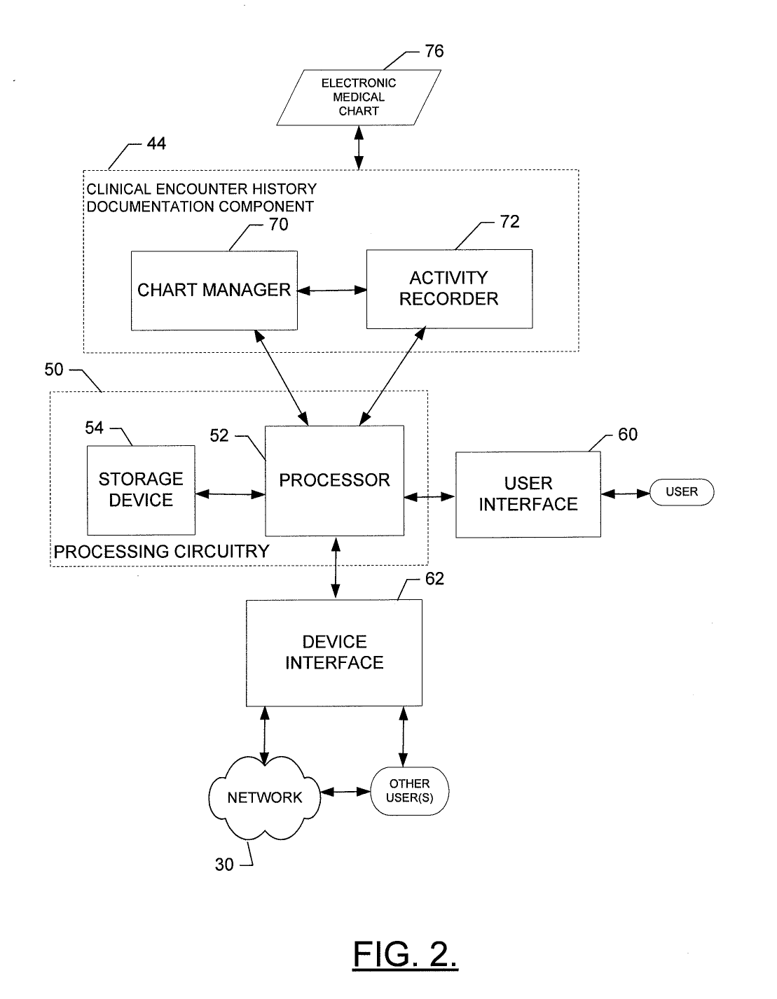

An example embodiment of the invention will now be described with reference to FIG. 2. FIG. 2 shows certain elements of an apparatus for provision of clinical encounter history documentation support according to an example embodiment. The apparatus of FIG. 2 may be employed, for example, on a client (e.g., any of the clients 20 of FIG. 1) or a variety of other devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

Referring now to FIG. 2, an apparatus for provision of clinical encounter history documentation support is provided. The apparatus may include or otherwise be in communication with processing circuitry 50 that is configured to perform data processing, application execution and other processing and management services according to an example embodiment of the present invention. In one embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device such as one of the clients 20) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, a cell phone, or other input/output mechanisms. In embodiments where the apparatus is embodied at a server or other network entity, the user interface 60 may be limited or even eliminated in some cases.

The device interface 62 may include one or more interface mechanisms for enabling communication with other devices and/or networks. In some cases, the device interface 62 may be any means such as a device or circuitry embodied in either hardware, software, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods. In situations where the device interface 62 communicates with a network, the network may be any of various examples of wireless or wired communication networks such as, for example, data networks like a Local Area Network (LAN), a Metropolitan Area Network (MAN), and/or a Wide Area Network (WAN), such as the Internet.

In an example embodiment, the storage device 54 may include one or more non-transitory storage or memory devices such as, for example, volatile and/or non-volatile memory that may be either fixed or removable. The storage device 54 may be configured to store information, data, applications, instructions or the like for enabling the apparatus to carry out various functions in accordance with example embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases (e.g., database server 42) that may store a variety of files, contents or data sets. Among the contents of the storage device 54, applications (e.g., client application 22 or service application such as the clinical encounter history documentation component 44) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an example embodiment, the processor 52 (or the processing circuitry 50) may be embodied as, include or otherwise control the clinical encounter history documentation component 44, which may include or otherwise control a chart manager 70 and an activity recorder 72. The chart manager 70 and the activity recorder 72 may each be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the chart manager 70 and the activity recorder 72, respectively, as described below.

The clinical encounter history documentation component 44 may be a component of, or may itself be, a tool for managing EMRs or other electronic patient health records, generally referred to hereinafter as a chart (e.g., electronic medical chart 76). As such, the clinical encounter history documentation component 44 may be configured to provide an interface for inputting data, modifying data and/or saving data to charts associated with various different patients. The chart manager 70 and the activity recorder 72 may enable a user to interface with the chart to facilitate data entry into the chart, and to provide for recordation of a history of activities performed with respect to the patient on a per-encounter basis as described in greater detail below.

In an example embodiment, the chart manager 70 may be configured to provide a structured organization of pages and/or interfaces to be presented to the user to represent corresponding sections of the chart. Thus, for example, the chart manager 70 may be configured to present a sequence of topic segregated pages for the entry or viewing of data related to healthcare related activities undertaken with respect to a patient. The chart manager 70 may support the creation of separate files for corresponding different patients with a common structure for the data stored in association with each file to form a corresponding patient chart. Each section of the chart may have a structure and interfaces designed to permit entry and review of data corresponding to a particular healthcare related topic for the patient. The chart manager 70 may be configured to provide the structure for the chart so that the data associated with each file can be viewed and various sections of the chart can be navigated between using the interfaces provided by the chart manager 70.

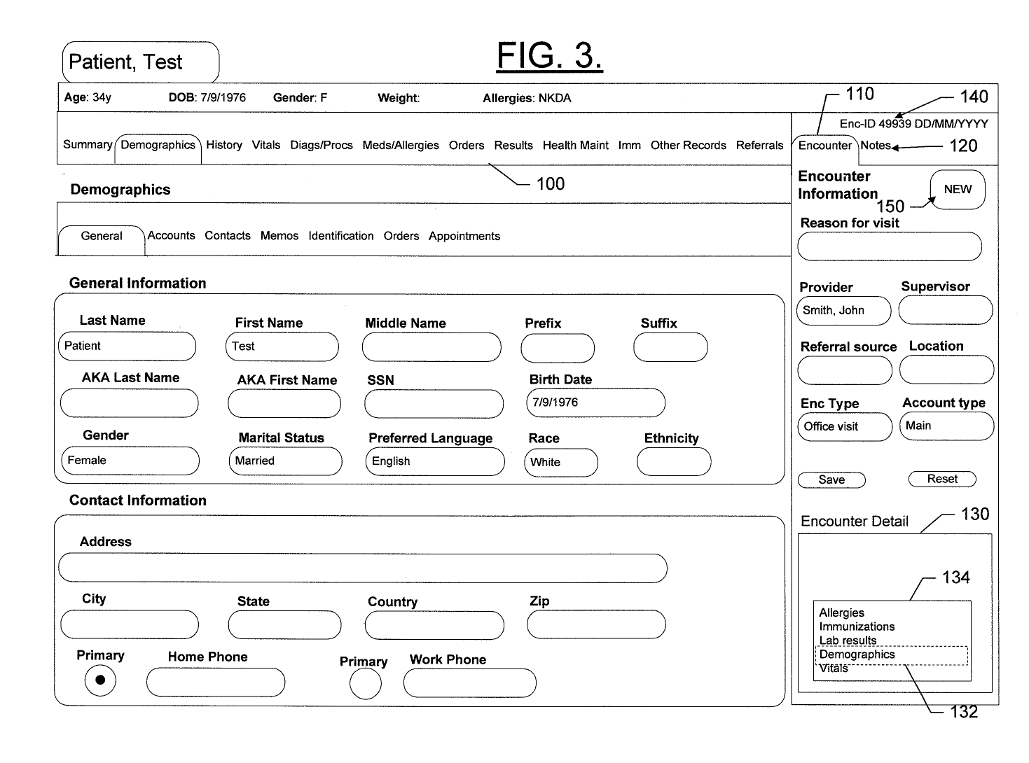

FIG. 3 illustrates an example of a chart for a sample patient (e.g., named Test Patient) that illustrates one example embodiment. As shown in FIG. 3, the chart may generally include a series of tabs 100 that each correspond to a respective different chart section. For example, separate tabs may be provided to enable viewing of chart sections devoted to summary information, demographic information, history information, vitals, diagnoses, medications and allergies, orders, results, health maintenance, immunizations, other records and referrals. In the example of FIG. 3, the demographics tab is selected and thus, demographic information associated with the sample patient is displayed. There may be further tabs and further data entry pages under each of the series of tabs 100.

Data may be entered and stored in association with the sample patient for any or all of the chart sections. When the sample patient is initially entered into the system, much of the demographic data, contact information, and other general data may be entered into the record to create the chart. Other data and chart sections will be filled in and utilized to store records of patient data for various visits or encounters that occur with the patient over time. However, when a patient is seen or receives treatment on any particular visit, only some of the data in any particular chart section may need to be modified to accommodate applicable changes and only some of the chart sections may be utilized to enter new data. To track the occurrences that are associated with any particular visit or encounter, an encounter details tab 110 may be provided. Meanwhile, in order to enable healthcare personnel to record notes regarding each encounter, a notes entry tab 120 may be provided.

The notes entry tab 120 may enable free text to be typed in to describe aspects of the interaction with the patient. Doctors are typically trained to record details of their patient interactions via notes. The notes entry tab 120 may provide access to a notes entry section to enable the doctors to type in free text descriptive of the interaction. In some embodiments, the notes entry section may also enable healthcare staff to input information that can be automatically propagated to other chart sections. For example, a code process or user interface functionality may be provided to enable entries made to the notes entry section to be identified for propagation to other chart sections. Since it is common for a patient making a doctor visit to see one or more other staff persons prior to seeing the doctor, and doctors often get preliminary information regarding the patient from the notes entry section based on entries made by the staff persons, some of the preliminary information (e.g., patient vitals) may be entered into the notes entry section. Thus, in some ways, the notes entry section may provide some information regarding activities that have been undertaken with respect to the patient for a current encounter. However, the notes entry section may not indicate all of the activity that has occurred for the current encounter. Accordingly, in some example embodiments, the activity recorder 72 may be configured to provide a history of each activity to enable all of the activities undertaken for an encounter to be viewed. In this regard, as described in greater detail below, the activity recorder 72 may be configured to record each activity performed in association with a particular encounter and also enable tracking of, and navigation between, encounters and the activities that occur in association with each encounter.

As shown in FIG. 3, when the encounter details tab 110 is selected, an encounter information window 130 may be opened. Each time a user enters data into one of the chart sections the interaction with the corresponding chart section is considered to be an instance of a recordable activity. Each activity is recorded or logged in association with a current encounter as an activity indicator 132. The encounter information window 130 displays a listing or set of activities defining an encounter trail or encounter history 134 that correspond to one specific encounter. Each encounter may be identified by an encounter identifier 140. The encounter history 134 essentially defines a trail or history of the activities that have been performed in connection with one encounter (and therefore one corresponding encounter identifier 140). In an example embodiment, the activity indicators may be arranged in sequential order within the encounter history 134. In some cases, if the same chart section is opened and data entered therein on two separate occasions during the same encounter, each entry will initiate a separate activity indicator. Thus, according to this example, two separate activity indicators may be provided to show when, in the sequence of all the activities that were undertaken for the encounter, each separate activity occurred.

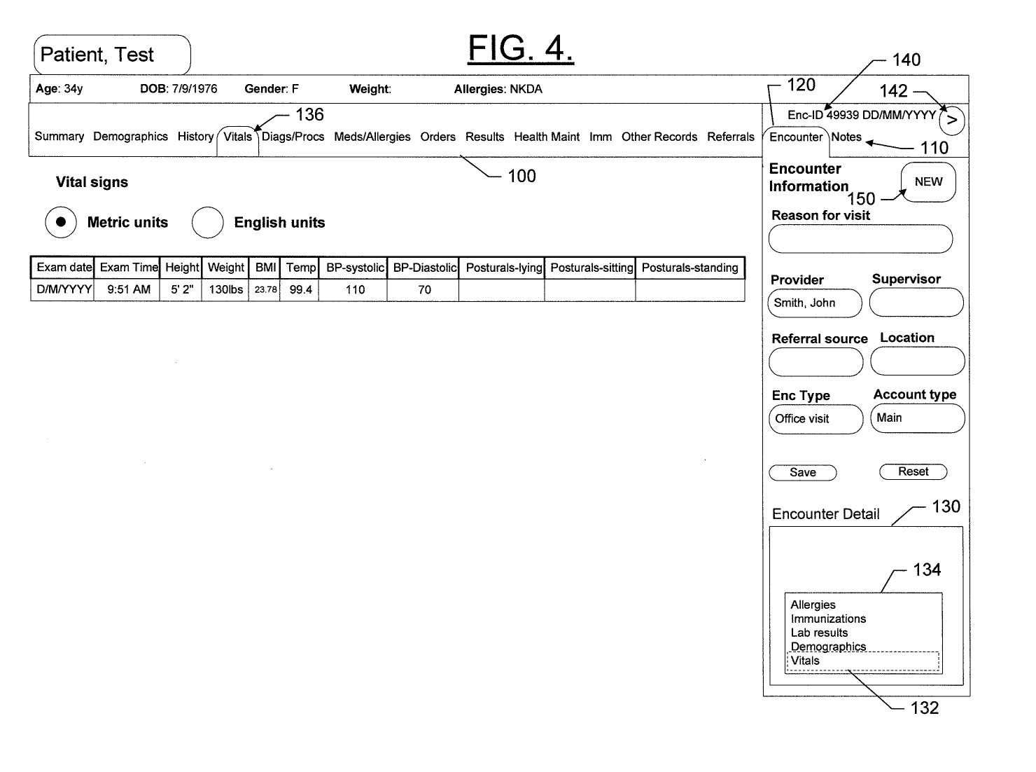

In an example embodiment, the encounter history 134 not only enables the user to see and appreciate the specific activities that have been performed in connection with the encounter referenced by the encounter identifier 140, but the encounter history 134 also indicates the order in which those activities occurred. Furthermore, in some examples, each activity indicator 132 may be selectable to link to the corresponding tab of the chart section that corresponds to the activity performed. Thus, for example, the user may be enabled to see each activity that has been performed for a specific encounter and then select one or more activity indicators in order to call up specific information about the corresponding activity or activities. As such, the encounter history 134 may provide a mechanism by which to navigate between chart sections that are relevant to a particular encounter. FIG. 4 illustrates an example in which selection of an activity indicator links to a corresponding chart section. In this example, the user has selected the activity indicator for vitals and thus, the vitals tab 136 has been selected to show the vitals information taken in association with the encounter identifier 140.

In an example embodiment, the encounter identifier 140 may be displayed in connection with a search function or drop down selector 142 to enable the user to select different encounter identifiers. Each different encounter identifier, if selected, may enable the user to view the corresponding set of activities that correspond to the selected encounter identifier. The encounter identifiers may be organized by date, in a sequential listing, or in any other desirable organizational manner. Information associated with each encounter may be indicated or entered for each respective encounter identifier. For example, the reason for the visit, provider information, information on the type of encounter, information on the type of account, and/or the like may be provided in association with each encounter identifier.

In some embodiments, any activities that occur on different days may, by default, be considered to be associated with different encounters. However, this functionality may be overridden if appropriate. In some cases, multiple encounters could be created on a given day. Typically, each encounter is associated with a single visit or appointment with a corresponding purpose. However, it is certainly possible that multiple appointments for different purposes, or even for the same purpose, may be made on the same day. Thus, a selection (e.g., “New” button 150) may be provided to stop a current encounter and begin a new one.

In an example embodiment, the actual building of the encounter history 134 may occur in real time or near real time. Thus, as each activity is performed, a corresponding activity indicator 132 may be created. The performance of the activity may be logged, stored or registered in response to entry of data, closing a chart section, switching to another chart section, saving data associated with a chart section, and/or the like. In some cases, it may be possible to edit data associated with an activity indicator 132. Edits may be performed only with proper authorization in some cases, or with entry of an authorization code, although some embodiments may operate without authorization requirements. When edits are made, the edited data may simply replace the previous data. However, if all data associated with an activity is deleted or otherwise removed, or if the activity indicator itself is deleted, the corresponding activity indicator and all data associated therewith may be deleted.

In some embodiments, since the encounter information window 130 may provide the encounter history 134 for a given encounter, healthcare staff may easily see what activities have been accomplished for a given visit in order to facilitate provider entered-orders, give immunizations, send charges to claims, and/or the like. Moreover, as indicated above, having easy access to a listing of activities undertaken in a given visit may also enable healthcare organizations to submit data for obtaining awards related to Meaningful Use standards. Thus, for example, deleting of records on the chart tabs will remove the corresponding activity indicator from the encounter history 134.

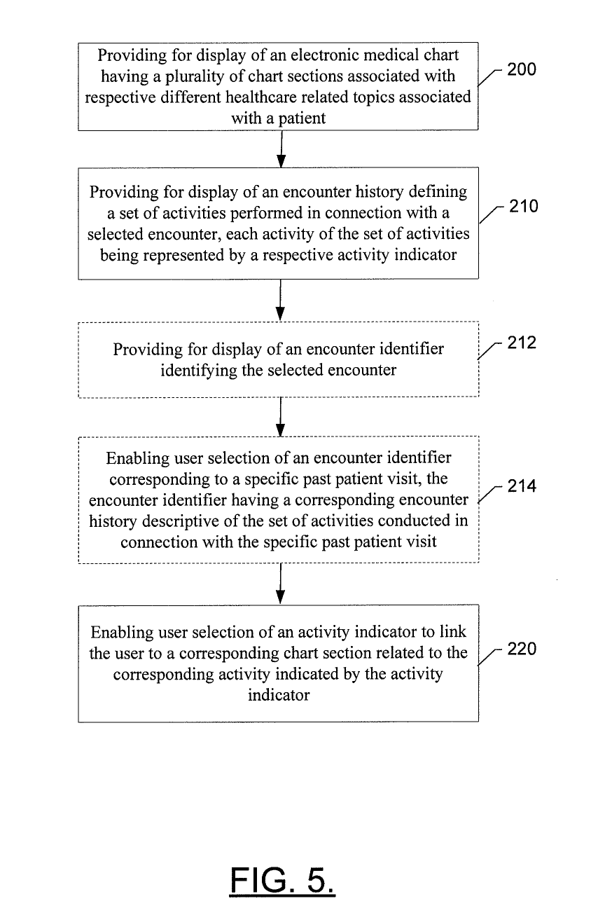

Embodiments of the present invention may therefore be practiced using an apparatus such as the one depicted in FIG. 2. However, other embodiments may be practiced in connection with a computer program product for performing embodiments of the present invention. FIG. 5 is a flowchart of a method and program product according to example embodiments of the invention. Each block or step of the flowchart of FIG. 5, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52).

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable storage medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one embodiment of the invention, as shown in FIG. 5, may include providing for display of an electronic medical chart having a plurality of chart sections associated with respective different healthcare related topics associated with a patient at operation 200, providing for display of an encounter history defining a set of activities performed in connection with a selected encounter where each activity of the set of activities is represented by a respective activity indicator at operation 210, and enabling user selection of an activity indicator to link the user to a corresponding chart section related to the corresponding activity indicated by the activity indicator at operation 220. In some cases, providing for display of the encounter history may include dynamically (e.g., in real time or near real time) updating the encounter history to include an additional activity indicator for each respective activity that is undertaken in relation to a corresponding different chart section of a current patient visit.

In some cases, the method may include additional optional operations (some examples of which are shown in dashed lines in FIG. 5). Any additional operations, and/or modifications to the operations above or the additional operations, may be performed in addition to the operations described above in any order and in any combination. Thus, in some embodiments, all of the additional operations or modifications may be practiced, while in others none of the additional operations or modifications may be practiced. In still other embodiments, any combination of less than all of the additional operations or modifications may be practiced. In an example embodiment, the method may further include providing for display of an encounter identifier identifying the selected encounter at operation 212. Alternatively or additionally, the method may include enabling user selection of an encounter identifier corresponding to a specific past patient visit where the encounter identifier has a corresponding encounter history descriptive of the set of activities conducted in connection with the specific past patient visit at operation 214. In some embodiments, providing for display of the encounter history may include providing for display of an encounter information window including information descriptive of the selected encounter and the encounter history. In some cases, providing for display of the encounter information window may include providing for display of the encounter information window simultaneously with the display of one of the chart sections. In some embodiments, providing for display of the encounter history may include providing a sequential listing of activity indicators in an order in which activities corresponding to each activity indicator occurred. Other modifications are also possible. The modifications and optional operations may be included in any combination and in any order with respect to the operations 200-220 described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of an electronic medical chart having a plurality of chart sections associated with respective different healthcare related topics associated with a patient;
providing for display of an encounter history defining a set of activities performed in connection with a selected encounter, each activity of the set of activities being represented by a respective activity indicator, the encounter history being dynamically updated to include an additional activity indicator for each respective activity that is undertaken in relation to a corresponding different chart section of a current patient visit; and
enabling, via processing circuitry, user selection of an activity indicator to link the user to a corresponding chart section related to the corresponding activity indicated by the activity indicator.

2. The method of claim 1, wherein providing for display of the encounter history comprises providing for display of an encounter information window including information descriptive of the selected encounter and the encounter history.

3. The method of claim 2, wherein providing for display of the encounter information window comprises providing for display of the encounter information window simultaneously with the display of one of the chart sections.

4. The method of claim 1, further comprising providing for display of an encounter identifier identifying the selected encounter.

5. The method of claim 1, further comprising enabling user selection of an encounter identifier corresponding to a specific past patient visit, the encounter identifier having a corresponding encounter history descriptive of the set of activities conducted in connection with the specific past patient visit.

6. The method of claim 1, wherein providing for display of the encounter history comprises providing a sequential listing of activity indicators in an order in which activities corresponding to each activity indicator occurred.

7. An apparatus comprising processing circuitry configured to:
provide for display of an electronic medical chart having a plurality of chart sections associated with respective different healthcare related topics associated with a patient;
provide for display of an encounter history defining a set of activities performed in connection with a selected encounter, each activity of the set of activities being represented by a respective activity indicator, the encounter history being dynamically updated to include an additional activity indicator for each respective activity that is undertaken in relation to a corresponding different chart section of a current patient visit; and
enable user selection of an activity indicator to link the user to a corresponding chart section related to the corresponding activity indicated by the activity indicator.

8. The apparatus of claim 7, wherein the processing circuitry being configured provide for display of the encounter history comprises the processing circuitry being configured to provide for display of an encounter information window including information descriptive of the selected encounter and the encounter history.

9. The apparatus of claim 8, wherein the processing circuitry being configured to provide for display of the encounter information window comprises the processing circuitry being configured to provide for display of the encounter information window simultaneously with the display of one of the chart sections.

10. The apparatus of claim 7, wherein the processing circuitry is further configured to provide for display of an encounter identifier identifying the selected encounter.

11. The apparatus of claim 7, wherein the processing circuitry is further configured to enable user selection of an encounter identifier corresponding to a specific past patient visit, the encounter identifier having a corresponding encounter history descriptive of the set of activities conducted in connection with the specific past patient visit.

12. The method of claim 7, wherein the processing circuitry being configured to provide for display of the encounter history comprises the processing circuitry being configured to provide a sequential listing of activity indicators in an order in which activities corresponding to each activity indicator occurred.

13. A computer program product comprising at least one computer-readable storage medium having computer-executable program code instructions stored therein, the computer-executable program code instructions comprising program code instructions for:
providing for display of an electronic medical chart having a plurality of chart sections associated with respective different healthcare related topics associated with a patient;
providing for display of an encounter history defining a set of activities performed in connection with a selected encounter, each activity of the set of activities being represented by a respective activity indicator, the encounter history being dynamically updated to include an additional activity indicator for each respective activity that is undertaken in relation to a corresponding different chart section of a current patient visit; and
enabling user selection of an activity indicator to link the user to a corresponding chart section related to the corresponding activity indicated by the activity indicator.

14. The computer program product of claim 13, wherein program code instructions for providing for display of the encounter history include instructions for providing for display of an encounter information window including information descriptive of the selected encounter and the encounter history.

15. The computer program product of claim 14, wherein program code instructions for providing for display of the encounter information window include instructions for providing for display of the encounter information window simultaneously with the display of one of the chart sections.

16. The computer program product of claim 13, further comprising program code instructions for providing for display of an encounter identifier identifying the selected encounter.

17. The computer program product of claim 13, further comprising program code instructions for enabling user selection of an encounter identifier corresponding to a specific past patient visit, the encounter identifier having a corresponding encounter history descriptive of the set of activities conducted in connection with the specific past patient visit.

18. The computer program product of claim 13, wherein program code instructions for providing for display of the encounter history include instructions for providing a sequential listing of activity indicators in an order in which activities corresponding to each activity indicator occurred.
